(19) United States
(12) Patent Application Publication
(10) Pub. No.: US 2018/0201393 A1
(43) Pub. Date: Jul. 19, 2018

(54) APPARATUS AND METHOD FOR PACKAGING AND DEPLOYING LARGE STRUCTURES USING HEXAGONS

(71) Applicant: Cory Lawrence Johns, Drain, OR (US)

(72) Inventor: Cory Lawrence Johns, Drain, OR (US)

(21) Appl. No.: 15/872,689

(22) Filed: Jan. 16, 2018

Related U.S. Application Data
(60) Provisional application No. 62/499,181, filed on Jan. 18, 2017.

(51) Int. Cl. B64G 1/00

(52) U.S. Cl. CPC B64G 1/002; E05D 11/00

(57) ABSTRACT

An apparatus and a method for packaging a large size flat structure into a hexagonal column, allowing higher packaging density without sacrificing the two-dimensional size of the flat structure, and for deploying and unstacking the hexagonal column.

### CROSS-REFERENCE TO RELATED APPLICATIONS

This application claims the benefit under 35 U.S.C. § 119(e) of U.S. Provisional Application Ser. No. 62/499,181 filed Jan. 18, 2017.

### FIELD OF INVENTION

This invention is in the technical field of packaging and deploying structures, and is particularly useful in packaging, launching and deploying large and giant structures to and in space and/or for collecting solar energy.

### BACKGROUND

Hexagons have been used in the construction of space structures, such as James Webb Space Telescope, because hexagons are not only the best approximation of circles but also have a high filling factor which means can also uniformly tile into a substantially flat structure with zero or minimal gap. However, the large or giant size of space structures poses a challenge in launching them into space, because of the limited size and shape of a launching vehicle, which is usually and generally in the shape of a cylinder.

Currently, to launch and deploy a large flat structure containing hexagon panels, the structure is folded into several groups of flat pieces of hexagons and once in space, these pieces are tiled back into one flat configuration. For example, the James Webb Space Telescope has a combined golden mirror with a diameter of 6.5 m containing 18 hexagonal-shaped mirror segments. To package the James Webb Space Telescope for launching, the mirror with a 6.5-meter-diameter is folded into three flat pieces like leaves of a drop-leaf table so that the mirror and the Telescope can fit into a launching rocket. Once launched in space, the pieces are unfolded and tiled back as the one-piece mirror, flat to flat. Information about the large golden mirror of the James Webb Space Telescope is available at https://jwst.nasa.gov/mirrors.html.

While a big or large flat structure can be packaged, launched and deployed by using hexagonal-shaped segments and by using the methods as in the James Webb Space Telescope, an apparatus and/or a method that allows the packaging, launching and deploying of much larger structures with diameters greater than the James Webb Telescope is desirable for commercial and scientific needs.

### SUMMARY

This invention addresses the packaging and deployment of a two-dimensional, flat structure containing hexagon panels. By connecting the hexagon panels in a particular sequence, this invention creates an apparatus and a method that allow the hexagon panels to be packaged or stacked into a hexagonal column which occupies significantly less space without losing any desired two-dimensional size of the structure once deployed. The apparatus is restored to be a flat structure by reversing the sequence when unfolding or unstacking the hexagons and then securing the hexagons with adjacent hexagons. This invention also allows much larger structures to be packaged, launched and deployed in space with current launching vehicles.

### BRIEF DESCRIPTION OF THE DRAWINGS

FIG. 1 is a two dimensional demonstration of an embodiment of the invented apparatus when it is in the form of a flat structure.

FIG. 2 shows the deployment process of an embodiment of the invented apparatus, from a hexagonal column to a flat configuration.

FIG. 3 shows an embodiment of the invention in the form of a hexagonal column expanded slightly.

FIG. 4 is an embodiment of the invention where the flat configuration of the apparatus is tiled to be a ring of hexagons having one complete layer of hexagons.

FIGS. 5A-5B illustrate two modes of an embodiment of the invention which includes an expandable member for adjusting the thickness of the hexagons. FIG. 5A shows an expanded mode of a hexagon. FIG. 5B shows the compressed mode of a hexagon.

### DETAILED DESCRIPTION

Embodiments of the invention is an apparatus and a method that use a unique sequence to connect hexagons for tiling the hexagons into a large flat configuration and by tracing the reverse direction of the connecting sequence, stacking the hexagons into a hexagonal column by folding the hexagons with alternating folding directions. The hexagonal column can be unstacked or unfolded to return the apparatus back to the form of a large flat configuration. When the apparatus is in the form of a flat configuration, the adjacent hexagons are secured with each other for the stability of the flat configuration.

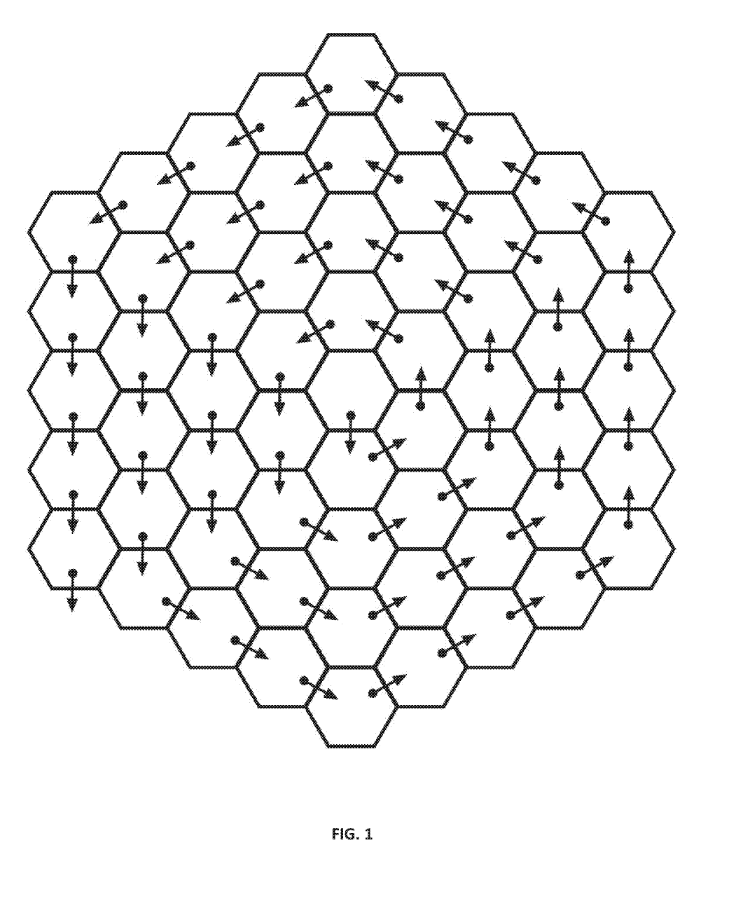

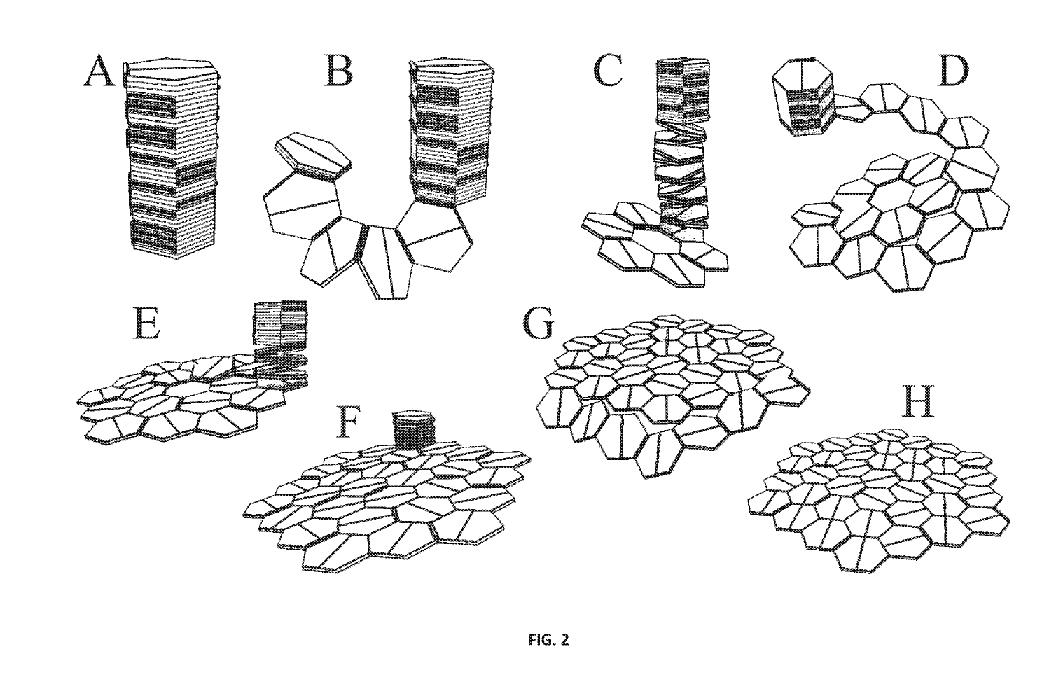

The arrows in FIG. 1 represent one direction of the connecting sequence for tiling the hexagon panels during initial construction. The direction of the connecting sequence shown in FIG. 1 may be reversed. Each arrow in FIG. 1 crosses a hinge or a connector that permanently connects the two adjacent hexagons. By following the generally circular direction of the connecting sequence, the hexagons can be tiled into a very large flat configuration with an unlimited number of hexagons. To construct the apparatus, each of the hexagons is permanently connected by following the connecting sequence, leaving no or minimal gap among adjacent hexagons and no overlapping hexagons. While it is easier to follow the order of the connecting sequence, it is also possible to connect the hexagons in any order so long as the hexagons are connected using the connecting sequence. To prepare for packaging and launching, the hexagons are stacked in alternating folding directions and by reversely tracing the connecting sequence (reversal of the arrow direction in FIG. 1), resulting in a hexagonal column as shown in FIG. 2A. The hexagonal column fits well inside a launching vehicle that is usually a cylinder.

Once launched into space and outside the launching vehicle, the apparatus in its hexagonal column shape (shown in FIG. 2A) is ready to be deployed. As shown in FIGS. 2B-2G, the hexagons are gradually deployed while being tiled to form a two-dimensional surface by tracing the connecting sequence as in FIG. 1. Once all the hexagons are deployed and tiled, the apparatus takes the form of the flat configuration (shown in FIG. 2H). The hexagons are then secured with adjacent hexagonal segments using securing members. Securing members are mounted on all sides of the hexagons that are not on the trace of the connecting sequence, which are the sides not crossed by arrows as shown in FIG. 1.

When deploying the hexagons, the hexagons may be deployed one by one. A more efficient way to deploy the hexagons is to deploy a number of hexagons simultaneously in a controlled manner to allow unfolding without colliding any hexagons. An example of simultaneously deploying a group of hexagons is shown in FIG. 3.

The hinges for connecting the hexagons may fold both directions or only one direction. In the embodiment where the hinges fold only one direction, the hinges must be mounted in an alternating top and bottom manner on the hexagons that follow the trace of the connecting sequence to allow the alternating folding directions of the hexagons. In the embodiment where the hinges fold both directions, the mounting direction of the hinges is irrelevant, but the stacking direction of the hexagons must follow alternating folding directions.

In one embodiment of the invention, the securing members and the hinges are one and the same, both of which are connectors serving the function of connecting the hexagons permanently when constructing the apparatus and securing the hexagons permanently once the apparatus is fully deployed and tiled.

The hinges, securing members, or connectors are powered in order to fold and unfold the hexagons as needed. The power may be electric, elastic (for example, using springs), magnetic, created by using a shape-memory material, or by chemical reactions.

The preferred construction and use of the invented apparatus contain hexagons without limitation of number, because the purpose of the invention is to allow a giant flat structure to be collapsed into a compact hexagonal column that takes a minimal space (cylindrical or elongated shape) for launching. However, because the minimum number required to form a ring of hexagons is six, six is the preferred minimum number of hexagons to be used for purpose of this invention.

The applications of the invented apparatus and method can be in connection with mirrors and solar cell arrays in or with the hexagon tiles. The two exterior surfaces of each of the hexagons (not interior surfaces between layers inside a hexagon if a hexagon comprises layers) should be clear from obstruction to allow consistent and unobstructed stacking.

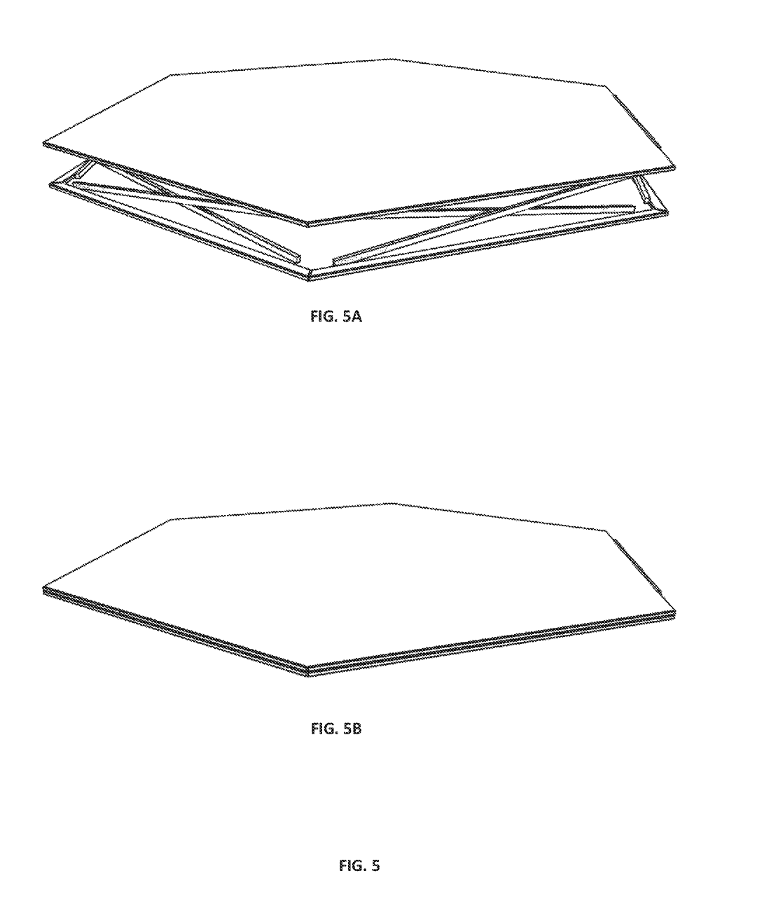

The height of a hexagonal column can be reduced by using hexagon tiles made of a material with the flexibility to be compressed and then restored when needed. Another embodiment of the invention uses an expandable member inside each hexagon tile for adjusting the thickness of the hexagon tiles. In this embodiment, the hexagon tiles comprises at least two layers and the expandable member is installed between the layers. The expandable member may use crossed bars along the hexagon sides as shown in FIG. 5A. The expandable member may use other mechanisms such as inflatable spacers, springs, and/or using a UV rigidizer. With the expandable member, the hexagonal column may be made shorter when packaging and launching, hence allowing the apparatus to connect even more hexagons to result into an even larger flat configuration.

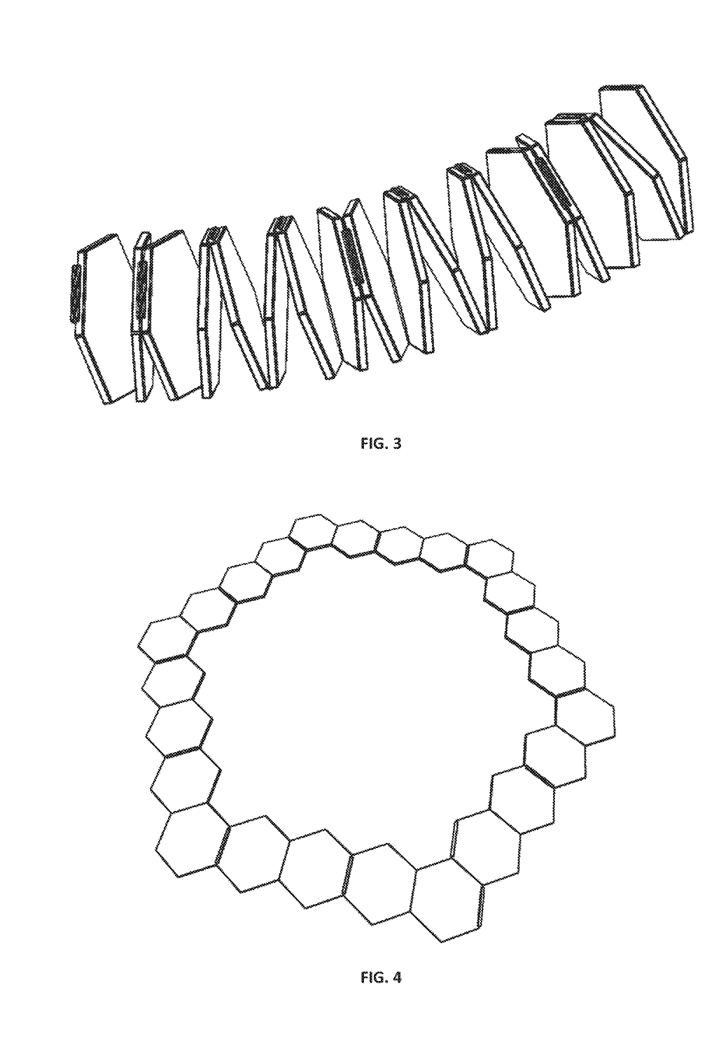

While it may be most useful to fully tile the flat configuration of the apparatus in one embodiment, for example, maximizing the area for collecting solar energy, it may be desirable to not fully tile the fiat configuration in another embodiment, for example, a ring of hexagons having only one complete circled layer of hexagons as shown in FIG. 4, or a flat configuration missing a center hexagon.

It is noted that, as used in this specification and the appended claims, the singular forms “a,” “an,” and “the,” include plural referents unless expressly and unequivocally limited to one referent. As used herein, the term “include” and its grammatical variants are intended to be non-limiting, such that recitation of items in a list is not to the exclusion of other like items that can be substituted or other items that can be added to the listed items.

Upon studying the disclosure, it will be apparent to those skilled in the art that various modifications and variations can be made in the invention and methods of various embodiments of the invention. Other embodiments will be apparent to those skilled in the art from consideration of the specification and practice of the embodiments disclosed herein. It is intended that the specification be considered as examples only. The various embodiments are not necessarily mutually exclusive, as some embodiments can be combined with one or more other embodiments to form new embodiments.

What is claimed is:

1. An apparatus for packaging and deploying large structures comprising:
a) a plurality of hexagon tiles;
b) a plurality of connectors mounted to the sides of the tiles and having a power source; and
c) a connecting sequence that connects the tiles permanently one by one using the connectors in a generally circular direction on a two-dimensional surface such that the apparatus takes the form of a flat configuration without any overlapping tiles and without noticeable gaps, wherein the tiles forming the flat configuration are then secured to adjacent tiles using the connectors for stability,
wherein
the apparatus forms a hexagonal column of stacked tiles by folding the tiles with alternating folding directions at the connectors by tracing the connecting sequence.

2. The apparatus of claim 1, wherein the flat configuration is fully tiled.

3. The apparatus of claim 1, wherein the flat configuration is partially tiled.

4. The apparatus of claim 1, further comprising an expandable member in each of the tiles for adjusting the thickness of the tiles.

5. The apparatus of claim 1, wherein the power source is electric.

6. The apparatus of claim 1, wherein the power source is elastic.

7. The apparatus of claim 1, wherein the power source is magnetic.

8. The apparatus of claim 1, wherein the power source is one or more chemical reactions.

9. An apparatus comprising:
a) a plurality of hexagons, each side of the hexagons being mounted with either a hinge or a securing member, the hexagons having no more than two hinges, the hinges and the securing members are powered by a power source; and
b) a connecting sequence for connecting the hexagons permanently one by one using the hinges and in a generally circular direction on a two-dimensional surface such that the apparatus takes the form of a flat configuration without any overlapping hexagons and without noticeable gaps, wherein each hexagon is then further connected to the adjacent hexagons using the securing members,
wherein
the apparatus forms a hexagonal column when the hexagons are all stacked by folding the hexagons in alternating folding directions at the hinges by tracing the connecting sequence.

10. The apparatus of claim 9, wherein each of the hinges folds only to one direction.

11. The apparatus of claim 9, wherein each of the hinges may fold to two opposite directions.

12. The apparatus of claim 9, further comprising an expandable member in each of the hexagons for adjusting the thickness of the hexagons.

13. The apparatus of claim 9, wherein the securing member is the hinge.

14. The apparatus of claim 9, wherein the power source is electric.

15. The apparatus of claim 9, wherein the power source is elastic.

16. The apparatus of claim 9, wherein the power source is magnetic.

17. The apparatus of claim 9, wherein the power source is one or more chemical reactions.

18. A method for launching and deploying to and in space large structures having a form of a substantially flat configuration, comprising:
a) connecting a plurality of hexagons one by one permanently at the sides by:
i) following a generally circular direction on a two-dimensional surface, and
ii) having each hexagon connected to no more than two hexagons, wherein the form of the substantially flat configuration has no overlapping hexagons and no noticeable gaps;
b) stacking the hexagons in an accordion-like fashion by folding them with alternating or opposite folding directions to form a hexagonal column;
c) placing the hexagonal column into a space launching vehicle for launch;
d) once in space and outside the launching vehicle, deploying the hexagonal column by unfolding the hexagons into the substantially flat configuration; and
e) securing the adjacent hexagons to each other for stability.

19. The method of claim 18, in which the deploying the hexagonal column comprises unfolding more than one hexagon simultaneously without colliding any of the hexagons.

20. The method of claim 18, further comprising reducing the thickness of the hexagons after stacking the hexagons in an accordion-like fashion, such that the height of the hexagonal column is reduced.
